(19) United States
(12) Patent Application Publication
(10) Pub. No.: US 2011/0239293 A1
(43) Pub. Date: Sep. 29, 2011

(54) AUDITING ACCESS TO DATA BASED ON RESOURCE PROPERTIES

(75) Inventors: Raja Pazhanivel Perumal, Issaquah, WA (US); Nir Ben-Zvi, Redmond, WA (US); Anders Samuelsson, Redmond, WA (US); Jeffrey B. Hamblin, Issaquah, WA (US); Ran Kalach, Bellevue, WA (US); Ziquan Li, Redmond, WA (US); Matthias H. Wollnik, Seattle, WA (US); Clyde Law, Seattle, WA (US)

(73) Assignee: Microsoft Corporation, Redmond, WA (US)

(21) Appl. No.: 12/730,241

(22) Filed: Mar. 24, 2010

(51) Int. Cl. G06F 21/00

(52) U.S. Cl. 726/21; 726/2

(57) ABSTRACT

Described is a technology, such as implemented in an operating system security system, by which a resource's metadata (e.g., including data properties) is evaluated against an audit rule or audit rules associated with that resource (e.g., object). The audit rule may be associated with all such resources corresponding to a resource manager, and/or by a resource-specific audit rule. When a resource is accessed, each audit rule is processed against the metadata to determine whether to generate an audit event for that rule. The audit rule may be in the form of one or more conditional expressions. Audit events may be maintained and queried to obtain audit information for various usage scenarios.

### BACKGROUND

Auditing access to objects is a valuable part of an operating system's security mechanism. Security audit events reveal the history of object access (generally who accessed what object, and when), which can be useful in diagnosing data access. This has practical implications in scenarios such as forensics investigation of data security breaches in organizations.

To improve system performance and eliminate noise, auditing rules are exposed by the operating system. This allows the system administrator to specify criteria under which a security audit event is triggered. For example, the administrator may set an audit rule on object access events for a particular object type (file objects, for example), specific subjects (users/groups), access decisions (granted or denied) or specific permissions.

Audit policies also allow the administrator to configure resource manager-wide audit policies. Such schemes allow object-related activities to be monitored without having to copy and synchronize audit policies across every individual object in the system. The drawback of this approach, however, is that it generates a lot of noise, floods the system log and reduces overall system performance. Thus, this approach is recommended only for diagnostics scenarios for access denied issues when the source of such an error is not highly visible from the user application.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a resource's metadata is evaluated against an audit rule or audit rules associated with that resource. The audit rule may be associated with the resource by a resource manager, e.g., for all such resources managed thereby, and/or a resource-specific audit rule or audit rules for that resource. When a resource is accessed, each audit rule is processed against the metadata (possibly in conjunction with environment properties/state data) to determine whether to generate an audit event for that rule.

In one implementation, the audit rule is in the form of one or more conditional expressions. If met, e.g., the result is TRUE, the audit event is generated.

The audit event may include various data regarding the event, e.g., access request success or failure, user data, user claims, resource data, resource attributes, type of access requested, environmental data, a failure or success reason, policy data, a timestamp and/or an audit identifier. The audit events may be maintained in a log, and/or a database, and queried to obtain audit information for various usage scenarios.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing example components in a computing environment for auditing resource access based on object metadata.

FIG. 2 is a representation of various information associated with an audit event and audit event log.

FIG. 3 is a flow diagram representing steps that may be taken by audit logic in determining whether to trigger an audit event when an object access request is received.

FIG. 4 shows an illustrative example of a computing environment into which various aspects of the present invention may be incorporated.

### DETAILED DESCRIPTION

Various aspects of the technology described herein are generally directed towards configuring a per-object audit policy based on an object's metadata, whereby audit triggers are influenced by changes to the object's metadata. Also described is allowing auditing rules to be defined using conditional expressions involving object (resource) properties, such as the sensitivity of a file, creator, project and the like. When the rule is processed, the conditional expression is evaluated against the object's properties (as well as possibly based upon environmental properties or other state data such as where the access request originated). If the expression evaluates to TRUE, an audit event is triggered; object access may also be granted or denied. This allows for objects to be audited based on the characteristics of the object independent of its physical location in the system.

It should be understood that any of the examples herein are non-limiting. Indeed, for purposes of explanation, access to objects/resources in the form of files is generally described herein, however a file is only one type of objects/resources; other objects/resources may include any set of data such as parts of files, database rows and/or columns and the like, as well as physical entities such as computers and peripherals, and/or virtual entities such as application roles. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used in various ways that provide benefits and advantages in computing and resource auditing in general.

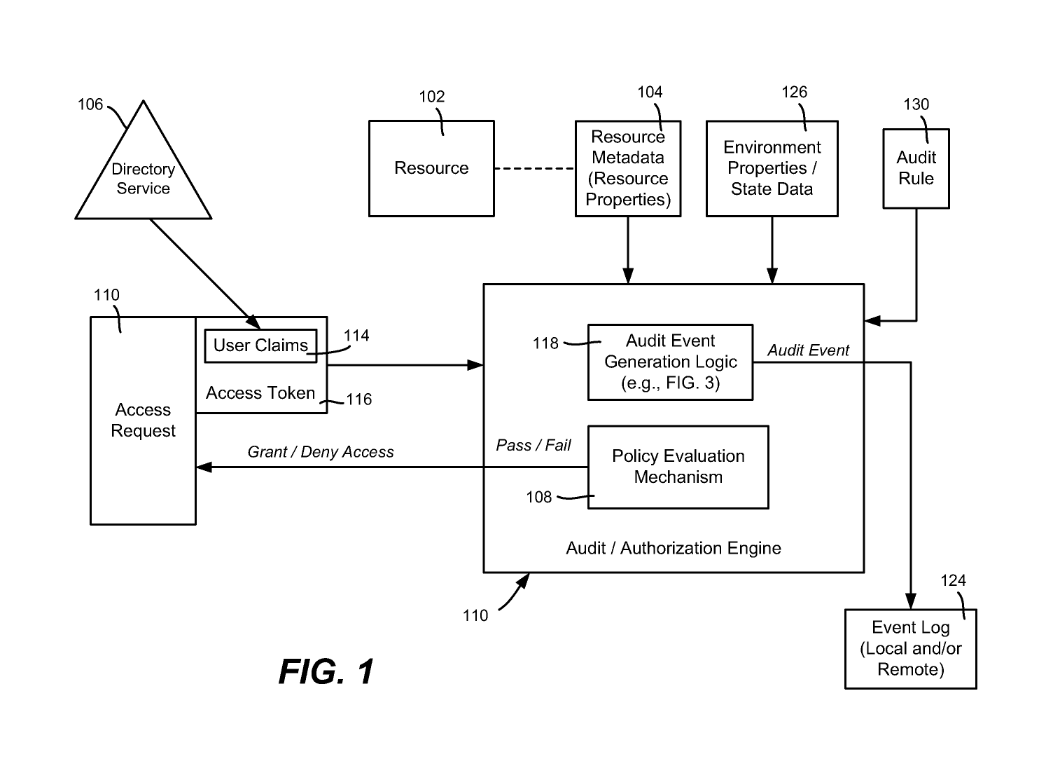

FIG. 1 shows an example computing environment in which a resource 102 is presently associated with resource metadata 104. For example, if the resource 102 is a file, such as accessed by a user who is defined in a directory service 106 (e.g., Active Directory®), in addition to conventional file attributes, the resource metadata 104 may include current information, such as whether the file contains sensitive data, as determined by a classification process. The classification process may perform real time resource tagging, e.g., by updating the classification metadata as needed as part of resource access. One such classification process, which may include processing content of a data item, is further described in U.S. patent application Ser. No. 12/427,755, hereby incorporated by reference. This technology is implemented in Microsoft Corporation's Windows® Server 2008 R2 as the File Classification Infrastructure (FCI) for defining and assigning classification properties to files and specifying actions to apply to files on file servers based on these properties, and is available as part of the file server resource manager (FSRM) server role.

The resource metadata 104 is associated with the resource 102 in some way, such as by a declarative classification rule that automatically assigns resource metadata to documents according to some rules, by a reference pointer to a cache of classification properties, in a central location such as a system-wide object database and/or by storing the resource label in an alternate data stream of a file resource, as described in U.S. patent application Ser. No. 12/605,451, entitled “Alternate Data Stream Cache for File Classification” hereby incorporated by reference. Note that some or all of the resource metadata may be inferred from classification rules, and are not necessarily stored. Moreover, any stored resource metadata 104 may be maintained in any way, including physically together with the resource 102 or physically separate from the resource 102 (e.g., in some database and/or other file), or some combination of both. This aspect of non-stored and/or stored, and if stored being independent of any particular physical association, is generally represented in FIG. 1 by the dashed line between the resource metadata 104 and the resource 102.

In general, the resource metadata 104 is evaluated by a policy evaluation mechanism 108 of an audit/authorization engine 110 to grant or deny an access request 112 based upon user claims 114/an access token 116 submitted to the operating system in conjunction with the access request. In addition to conventional access control list (ACL) evaluation versus the access token 116 to determine whether to grant or deny access, some or all of the resource metadata 104 may be evaluated against policy, as further described in U.S. patent application Ser. No. 12/622,441 hereby incorporated by reference.

Thus, the resource metadata 104 contains information that can be used in conjunction with the user claims 114 to apply policy. However, if cached, the resource metadata 104 may be out-of-date or otherwise invalid. For example, there are a number of ways in which a cached resource label may be out-of-date, including if the file is modified or moved (thereby making the properties out-of-date); this thus includes content changes, and/or if the file is renamed or moved to another location within the file system (which may result in a classification change based on the new location). Another way cached resource metadata becomes invalid is if the classification rules (described in the aforementioned U.S. patent application Ser. No. 12/427,755) used in the previous classification have since been modified, and/or if the internal state or configuration of modules that determine classification is modified. For example, even if the classification rules are unchanged, the ordering and/or way of combining two or more classification rules may change, and any such state change may result in a different file property classification result and thereby an invalid cached resource label.

Thus, before evaluating the resource metadata 104 against the user claims, the metadata's validity and up-to-date-state is checked to determine whether reclassification is needed. If so, reclassification is performed, as described in the aforementioned U.S. patent applications. Note that part or all of the cached property set may be checked for validity and/or part or all of the resource reclassified to update the cached property set.

As described herein, in addition to allowing or denying the access request 112, audit event generation logic 118 of the audit/authorization engine 110 determines whether to generate an audit event for logging in an audit event log 124. This may be based on the resource metadata 104 and/or on environment properties/state data 126. Examples of environment properties include criteria such as time of day, date, origin of the request (e.g., outside of Switzerland) and so forth.

As will be understood, the ability to audit based on object metadata has a number of practical uses. For example, security administrators often need to secure access to sensitive data in enterprise servers such as the file servers, databases, collaboration servers (e.g. SharePoint®) and so forth. As part of security, administrators audit access attempts to sensitive data across multiple servers and report on who accessed sensitive data in these systems. Auditing based on resource metadata facilitates such actions as auditing access to files created/owned by a specific user or security group, auditing access to specific file types/extensions (e.g. database files, spreadsheets), auditing access to files created in a specific date range, auditing access to files that carry sensitive content or are marked as confidential, auditing access to files that belong to a particular project, or part of an organization, and so forth.

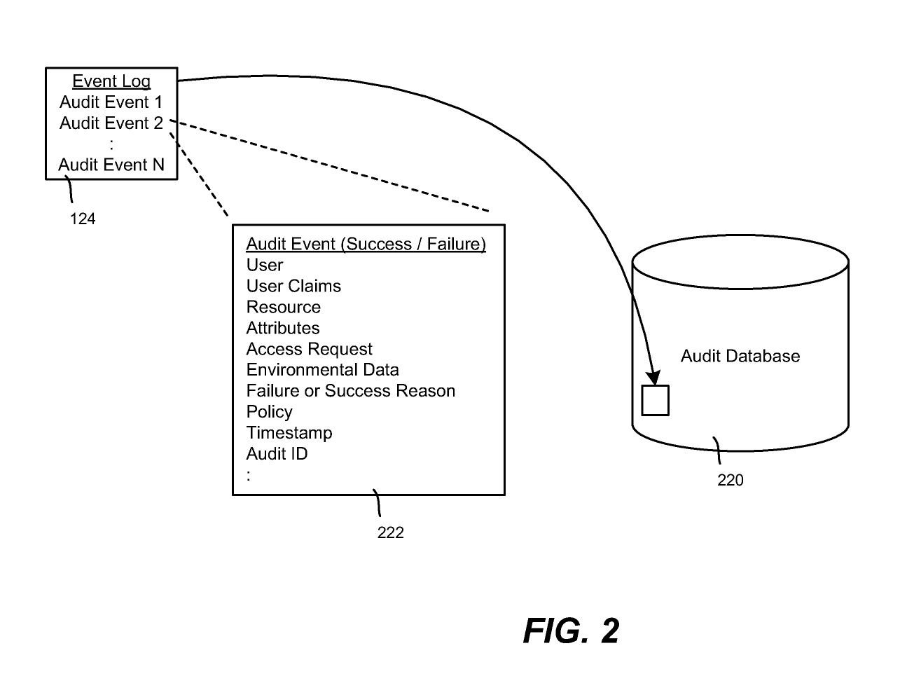

As represented in FIGS. 1 and 2, the event log 124 may be maintained locally with respect to the machine whose access request triggered the audit event, or for additional security, may be maintained remotely, e.g., in an audit database 220. An event log may be copied from local to remote storage, e.g., relatively often to avoid tampering.

Each audit event 222 in the event log 124 comprises a data structure (e.g., a string, database column data, a file or the like) that maintains information about the audit event 222. Note that an audit event 222 may be generated on a successful access attempt, a failed access attempt, or any attempt regardless of success or failure, and this information may be maintained as part of the audit event. Some of the other information maintained for an audit event 222 is represented in FIG. 2, and may include data relative to who and what triggered the audit event, the results, the time and so forth, such as the user, user claims, the resource, attributes, access request, environmental data, failure or success reason, policy, timestamp, an audit ID and so forth. Various example uses of such data are described below.

In one implementation, an audit rule 130 (FIG. 1) is created and provided to the audit/authorization engine 110. As described below, there may be zero or more audit rules as determined by an administrator or the like, and each audit rule may be associated with a resource manager (e.g., apply to all files) or with the specific resource/object (e.g., audit this particular file). The audit rule may be in the form of one or more conditional expressions with the object metadata 104 corresponding to one or more variables in the expression(s). The evaluation of object metadata by conditional expressions allows dynamic triggering of audit events based on object characteristics such as the sensitivity of the file, days since creation, and so forth.

The following sets forth some examples of conditional expressions in audit rules on files:
“Audit Success read Everyone if (@Resource.sensitivity==‘HBI’ AND (@Resource.project==‘foo’ OR @Resource.project==‘bar’))”
→evalutes to TRUE if the file sensitivity is marked as HBI (high business impact) and belongs to either project foo or bar. The rule sets an audit trigger for any successful read access if the condition returns TRUE.
“Audit read Everyone if (@Resource.salesRegion==‘Asia’ AND @Resource.customer==‘XYZCorp’)”
→evaluates to TRUE if the file belongs to the appropriate sales region and customer. The rule sets an audit trigger for any request for read if condition returns TRUE.
Audit read/delete if (‘@resource.sensitivity==‘High’ AND @resource.project==‘foobar’)
→evaluates to TRUE if the file sensitivity is marked as High and the file belongs to project foobar. The rule sets an audit trigger for any successful read/delete access if the condition returns TRUE.

Each audit rule may be used in conjunction with the user, permission, success/failure criteria supported by existing audit rule frameworks. An audit rule may be set on a specific object. An audit rule also may be set on multiple objects at a resource manager scope. For example, a file system such as NTFS may be a resource manager, whereby the resource manager scope may correspond to the files of that file system; SharePoint® is another example of a resource manager of multiple resources.

In one implementation, the resource (object) metadata is expressed conventionally as name value pairs, for example ‘sensitivity=High’, ‘days since creation=20 ’ and so forth. The metadata 104 can be relatively static (e.g. creator, title, file extension), or may be relatively dynamic (sensitivity of the file, days since creation and so forth). The metadata 104 needs to be adequately secured according to the requirements; discretionary and mandatory access control models may be used, as appropriate for a given scenario. For example, certain properties such as the sensitivity of the file may be secured using a mandatory model, whereas less sensitive properties may be modifiable by the object owner.

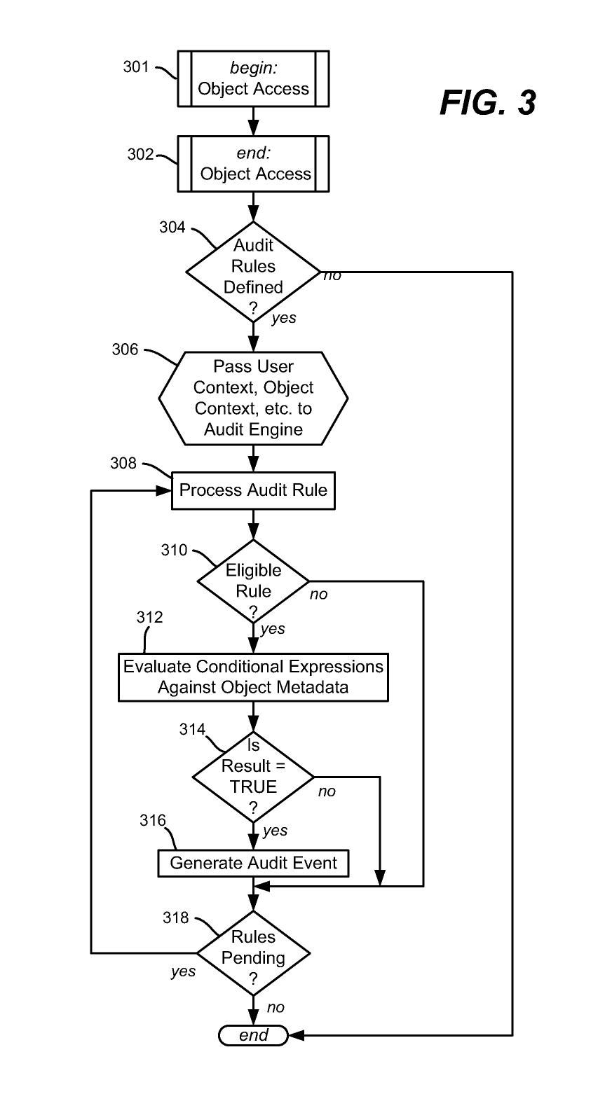

FIG. 3 shows general steps that may be taken in audit rule processing, which in general applies to audit rules for the resource manager scope as well as to audit rules in the object scope. Note that with respect to an audit rule in the resource manager scope, ‘global’ audit rules are processed for object access across the set of objects controlled by the resource manager (e.g., all file objects for a file system-type resource manager). As described below, if the resource manager scope audit rule applies, the conditional expression(s) are evaluated against the metadata of the object to which access is being requested. If the object itself has auditing rules specified, those per-object audit rules may be evaluated, such as following any global audit rule processing.

At steps 301 and 302, when access to a securable resource (referred to as an object in FIG. 3) is requested (by a principal), the operating system security mechanism evaluates access to the object given the user context (user claims) and the security descriptor (e.g., ACL and/or other policy) of the object. Access is thus granted or denied.

Step 304 represents the further audit evaluation process, which checks to see if the object is configured for audit events, that is, whether there are one or more audit rules defined for the object. If yes, at step 306 the result of the access request evaluation (access granted/denied), the user context, the permissions granted/denied are passed to the audit logic 118 (FIG. 1), along with the object context. The object context contains the auditing rule associated with the object (such as in a security descriptor) and the object metadata.

At steps 308 and 310, the audit logic evaluates the auditing rule to determine if an event needs to be triggered or not. The audit rule is checked for eligibility by evaluating certain criteria such as the subject, the permissions, success/failure and so forth. For example, an audit rule that specifies that only access denied (access failure) may possibly result in an audit event being triggered will filter out successful accesses at step 310.

If the audit rule is deemed eligible at step 310, the conditional expression or expressions in that audit rule are evaluated against the object metadata at step 312. If the conditional expression is satisfied for the object, that is, the result is TRUE (step 314), an audit event is generated at step 316 (and logged as desired).

Step 318 repeats for any other rules that may be pending with respect to the object access.

When used in the object scope, the auditing scheme described herein offers a flexible, dynamic audit policy that is influenced by the changes in object metadata. This allows an administrator to establish criteria for generating audits based on object properties, such as the sensitivity of the file, the creator or the project with which it is associated, and so forth. When the object characteristics change, the results of the audit rules also may change. This allows dynamic auditing in scenarios where a file is changed under a different project, the file is modified with sensitive data, when the file size exceeds a certain limit, and so forth.

When used in the resource manager scope, the auditing scheme described herein allows for logical scoping of objects based on object characteristics independent of the physical location. For example, files classified as ‘sensitive’ are automatically audited for access independently of where the file is stored in the system. This allows an administrator to configure the audit system to answer questions such as who accessed what sensitive data in the system, and when. The technology described herein also reduces the storage requirements needed for a resource manager-scoped audit policy, as only relevant objects are audited under the scheme. This saves the administrator time and effort to sort through a possibly very large number of object access events to filter for certain types of events.

As can be readily appreciated, once collected, the audit event data may be used (e.g., queried against) in various ways, including forensic analysis, e.g., who had access to a file that corresponds to leaked information. Monitoring for breaches (more proactively that forensic analysis, e.g., before any actual leak) may also be implemented.

A pattern may be identified for further investigation, such as early detection of a potential problem. For example, the same person (or automated process) keeps trying but failing to access some sensitive documents, without he or she having any apparent reason to do so. A pattern detection warning as to that person's possibly improper pattern of behavior may be generated.

Another use of the audit data is to obtain various lists as desired (e.g., by querying the database 220), such as who has accessed a file within the last thirty days. Files may be grouped by business groups, people, patterns and so forth. For example, auditing that results in a recognizable pattern or the like may be used to develop policy; e.g., only the finance group ever accesses this group of files, so henceforth access may be limited by access policy to only to the finance group.

Another use of audit data is to test for consequences of a new (including revised) candidate policy that may be applied before actually applying the new policy. For example, whenever a new policy is developed, there is a potential for unforeseen consequences (e.g., sales suddenly cannot access their sensitive customer files because the new policy forgot to give the sales group access). To test such a new policy as a candidate for implementation, the new policy may be implemented first as an audit policy. The audit event data that is collected will show who is denied and why, whereby any significant problems in such a policy may be quickly identified and fixed before being actually implemented as an access policy in a system.

There is thus described the ability to configure and use a per-object audit policy based on the object's metadata, whereby audit triggers are influenced by changes to the object's metadata. There is also described the configuration and use of resource manager-wide audit policies based on resource (object) metadata, which allows dynamic auditing of objects independent of the physical location of the object in the system. The audit rules may be created using conditional expressions involving resource metadata variables.

The audit logic/mechanism supports auditing rules based on resource metadata (e.g., object properties). The audit rule may be constructed as a conditional expression with object properties corresponding to the variables, and the audit event triggered when the audit rule's conditional expression(s) evaluates to TRUE. The policy can be set on the object scope and/or resource manager scope. When used in conjunction with real time resource tagging, the audit events can be triggered based on content changes and the like.

### Exemplary Operating Environment

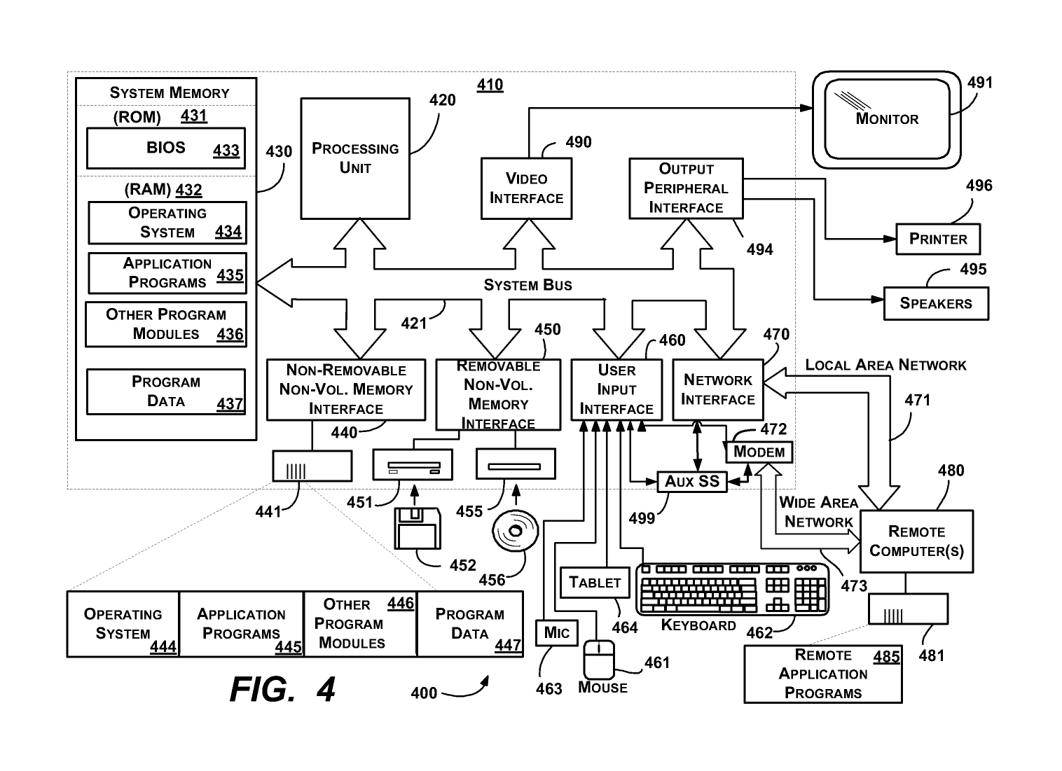

FIG. 4 illustrates an example of a suitable computing and networking environment 400 on which the examples of FIGS. 1-3 may be implemented. The computing system environment 400 is only one example of a suitable computing environment and is not intended to suggest any limitation as to the scope of use or functionality of the invention. Neither should the computing environment 400 be interpreted as having any dependency or requirement relating to any one or combination of components illustrated in the exemplary operating environment 400.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 4, an exemplary system for implementing various aspects of the invention may include a general purpose computing device in the form of a computer 410. Components of the computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 410 typically includes a variety of computer-readable media. Computer-readable media can be any available media that can be accessed by the computer 410 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 410. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, other program modules 436 and program data 437.

The computer 410 may also include other removable/non-removable, volatile/nonvolatile computer storage media. By way of example only, FIG. 4 illustrates a hard disk drive 441 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 421 by a removable memory interface, such as interface 450.

The drives and their associated computer storage media, described above and illustrated in FIG. 4, provide storage of computer-readable instructions, data structures, program modules and other data for the computer 410. In FIG. 4, for example, hard disk drive 441 is illustrated as storing operating system 444, application programs 445, other program modules 446 and program data 447. Note that these components can either be the same as or different from operating system 434, application programs 435, other program modules 436, and program data 437. Operating system 444, application programs 445, other program modules 446, and program data 447 are given different numbers herein to illustrate that, at a minimum, they are different copies. A user may enter commands and information into the computer 410 through input devices such as a tablet, or electronic digitizer, 464, a microphone 463, a keyboard 462 and pointing device 461, commonly referred to as mouse, trackball or touch pad. Other input devices not shown in FIG. 4 may include a joystick, game pad, satellite dish, scanner, or the like. These and other input devices are often connected to the processing unit 420 through a user input interface 460 that is coupled to the system bus, but may be connected by other interface and bus structures, such as a parallel port, game port or a universal serial bus (USB). A monitor 491 or other type of display device is also connected to the system bus 421 via an interface, such as a video interface 490. The monitor 491 may also be integrated with a touch-screen panel or the like. Note that the monitor and/or touch screen panel can be physically coupled to a housing in which the computing device 410 is incorporated, such as in a tablet-type personal computer. In addition, computers such as the computing device 410 may also include other peripheral output devices such as speakers 495 and printer 496, which may be connected through an output peripheral interface 494 or the like.

The computer 410 may operate in a networked environment using logical connections to one or more remote computers, such as a remote computer 480. The remote computer 480 may be a personal computer, a server, a router, a network PC, a peer device or other common network node, and typically includes many or all of the elements described above relative to the computer 410, although only a memory storage device 481 has been illustrated in FIG. 4. The logical connections depicted in FIG. 4 include one or more local area networks (LAN) 471 and one or more wide area networks (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the Internet. The modem 472, which may be internal or external, may be connected to the system bus 421 via the user input interface 460 or other appropriate mechanism. A wireless networking component such as comprising an interface and antenna may be coupled through a suitable device such as an access point or peer computer to a WAN or LAN. In a networked environment, program modules depicted relative to the computer 410, or portions thereof, may be stored in the remote memory storage device. By way of example, and not limitation, FIG. 4 illustrates remote application programs 485 as residing on memory device 481. It may be appreciated that the network connections shown are exemplary and other means of establishing a communications link between the computers may be used.

An auxiliary subsystem 499 (e.g., for auxiliary display of content) may be connected via the user interface 460 to allow data such as program content, system status and event notifications to be provided to the user, even if the main portions of the computer system are in a low power state. The auxiliary subsystem 499 may be connected to the modem 472 and/or network interface 470 to allow communication between these systems while the main processing unit 420 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method performed on at least one processor, comprising, determining whether a resource has at least one associated audit rule, including any per-resource audit rule or any resource manager audit rule, or both, and if so, processing each rule, including evaluating each eligible rule against metadata associated with the resource to determine whether to generate an audit event, and if so, generating the audit event corresponding to that audit rule.

2. The method of claim 1 further comprising, determining whether each rule is eligible for evaluating against the metadata.

3. The method of claim 2 further comprising, obtaining success or failure information as to whether access to the resource was granted or denied, and wherein determining whether each rule is eligible comprises evaluating the success or failure information.

4. The method of claim 1 wherein at least one audit rule includes a conditional expression having at least one variable corresponding to information included in the metadata, and wherein evaluating that rule against the metadata comprises evaluating the conditional expression.

5. The method of claim 4 further comprising, obtaining environment or state information, and wherein evaluating the conditional expression comprises using the environment or state information.

6. The method of claim 1 wherein the audit event is generated, and further comprising, logging the audit event.

7. The method of claim 1 further comprising, maintaining a database of audit events, and querying the database to develop a list of audit events that meet a set one or more query criteria.

8. The method of claim 1 wherein the audit event is generated, and further comprising, using the audit event to perform forensic analysis, resource monitoring, or pattern detection.

9. The method of claim 1 wherein the audit event is generated, and further comprising, using the audit event in testing a candidate access policy.

10. The method of claim 1 further comprising, obtaining the resource metadata from resource classification obtained via one or more classification rules.

11. In a computing environment, a system comprising, a security mechanism, including audit logic that processes metadata associated with a resource against audit policy, the audit policy including at least one audit rule including a conditional expression, the metadata including information corresponding to at least one variable in the conditional expression, the audit logic configured to generate an audit event when the conditional expression is met, and an event log that logs the audit event.

12. The system of claim 11 wherein security mechanism comprises an audit and authorization engine, the audit and authorization engine further including an access policy mechanism that grants or denies access to the resource based on user claims.

13. The system of claim 12 wherein the audit logic is configured to determine whether at least one audit rule is eligible for processing against the metadata based on whether the access policy mechanism granted or denied access to the resource.

14. The system of claim 11 wherein the audit policy includes at least one resource manager audit policy that provides auditing of resources independent of a physical location of the resource.

15. The system of claim 11 wherein the audit policy includes at least one resource-specific audit policy.

16. The system of claim 11 wherein the resource comprises a file and wherein the resource metadata is cached in an alternate data stream of the file.

17. The system of claim 11 wherein the audit event includes data corresponding to access request success or failure, user data, user claims, resource data, resource attributes, type of access requested, environmental data, a failure or success reason, policy data, a timestamp or an audit identifier, or any combination of access request success or failure, user data, user claims, resource data, resource attributes, type of access requested, environmental data, a failure or success reason, policy data, a timestamp or an audit identifier.

18. One or more computer-readable media having computer-executable instructions, which when executed perform steps, comprising:
(a) determining whether an audit rule of a set of one or more pending audit rules is eligible for evaluating against resource metadata, and if not, advancing to step (d);
(b) evaluating one or more conditional expressions in the audit rule against resource metadata to determine whether to generate an audit event, and if not, advancing to step (d);
(c) generating the audit event; and
(d) removing the audit rule from the pending set; and
(e) returning to step (a) for each other audit rule in the pending set, until none remain.

19. The one or more computer-readable media of claim 18 wherein the pending audit rules includes at least one resource manager audit policy or at least one resource-specific audit rule, or includes both at least one resource manager audit policy and at least one resource-specific audit rule.

20. The one or more computer-readable media of claim 18 wherein determining whether an audit rule is eligible for evaluating against the resource metadata comprises determining eligibility based upon subject, permissions or access success/failure data, or any combination of subject, permissions or access success/failure data.
